(19) United States
(12) Patent Application Publication
(10) Pub. No.: US 2008/0016525 A1
(43) Pub. Date: Jan. 17, 2008

(54) Cable TV a la carte

(75) Inventors: Yigang Cai, Naperville, IL (US); Shiyan Hua, Lisle, IL (US)

Correspondence Address: DOCKET ADMINISTRATOR;LUCENT TECHNOLOGIES INC., ROOM 2F-192, 600-700 MOUNTAIN AVENUE, MURRAY HILL, NJ, 07974-0636, US

(73) Assignee: Lucent Technologies Inc.

(21) Appl. No.: 11/485,818

(22) Filed: Jul. 13, 2006

(51) Int. Cl. H04N 7/173; H04N 7/16

(52) U.S. Cl. 725/1; 725/5; 725/100; 725/131

(57) ABSTRACT

A method and apparatus for providing cable TV a la carte service, wherein customers only pay for programs actually presented to their TV monitors. Customers are provided with keys for unscrambling TV signals from any channel provided by a service provider. The customers signal to the service provider the identification of a channel being provided to their monitor whenever they turn on their TV. The service provider uses the record of times and channels to perform charging for the customer. Advantageously, customers need not pay for programs not presented to their monitors.

### TECHNICAL FIELD

This invention relates to a method and apparatus for providing cable TV viewers with access to most or all of the cable TV channels and charging the viewers only for selections that are actually presented to their TV monitor.

### BACKGROUND OF THE INVENTION

The TV cable industry has been able to support the provision of a large number of TV channels to cable TV customers. Because of the difficulties of charging these customers based on the programs actually presented on their TV monitors (popularly known as TV a la carte), the most typical kinds of arrangements provide customers with unlimited access to a limited number of channels (e.g., gold, silver, bronze, basic packages) and permitting the customers to request programs not provided by their limited set of channels on an individual basis. To get one of these programs, a customer signals the cable service provider with an indication of the channel, time, and length of the program. The cable service provider arranges to transmit a key for unscrambling the TV signal for the desired program and arranges to charge the customer for that program in addition to the basic monthly charge for the service provided by the selected group of channels.

A problem of the prior art is that this arrangement forces customers effectively to pay for programs that they do not actually receive on their monitors. Another problem is that the procedure for obtaining access to a special program is awkward for the customer and requires the use of substantial resources by the cable TV service provider.

### SUMMARY OF THE INVENTION

The above problems are solved and an advance is made over the teachings of the prior art in accordance with this invention wherein a customer receives unscrambling keys for all channels at all times and automatically reports to the service provider the identity of each channel that is being connected to the customer's TV monitor whenever such a connection is made. Advantageously, the service provider receives all information for any programs being presented to the monitor (and therefore available for viewing) and can therefore prepare a bill which represents only those TV programs.

In accordance with one aspect of Applicants' invention, the TV signal which is transmitted to the customer is scrambled and the customer is provided with either a master key for unscrambling any channel or a set of keys for unscrambling any channel. Advantageously, it is not necessary to send keys for each program that the customer wishes to watch.

In accordance with one feature of Applicants' invention, keys for a limited number of channels, e.g., channels transmitting pornographic material, are not provided to the customer, either through the use of a separate master key for these channels, or through the use of individual keys for these channels these latter keys not being provided to the customer. Advantageously, the customer can block certain channels known to transmit objectionable material.

In accordance with one feature of Applicants' invention, the customer's set-top box (Cable TV receiver box) automatically transmits information to a TV service provider identifying the channel and the time for any program which is being transmitted to the TV monitor for viewing by the customer. The service provider can then prepare a bill for the customer, the bill representing only those programs that were actually transmitted to the customer's TV monitor.

### BRIEF DESCRIPTION OF THE DRAWINGS

FIG. 1 is a block diagram representing the arrangements for cable TV in the prior art;

FIG. 2 is a block diagram representing the cable TV arrangement in accordance with Applicants' invention;

FIG. 3 is a flow diagram for providing data to a service provider for calculating charges in accordance with Applicants' invention; and

FIG. 4 is a flow diagram illustrating the process of calculating charges.

### DETAILED DESCRIPTION

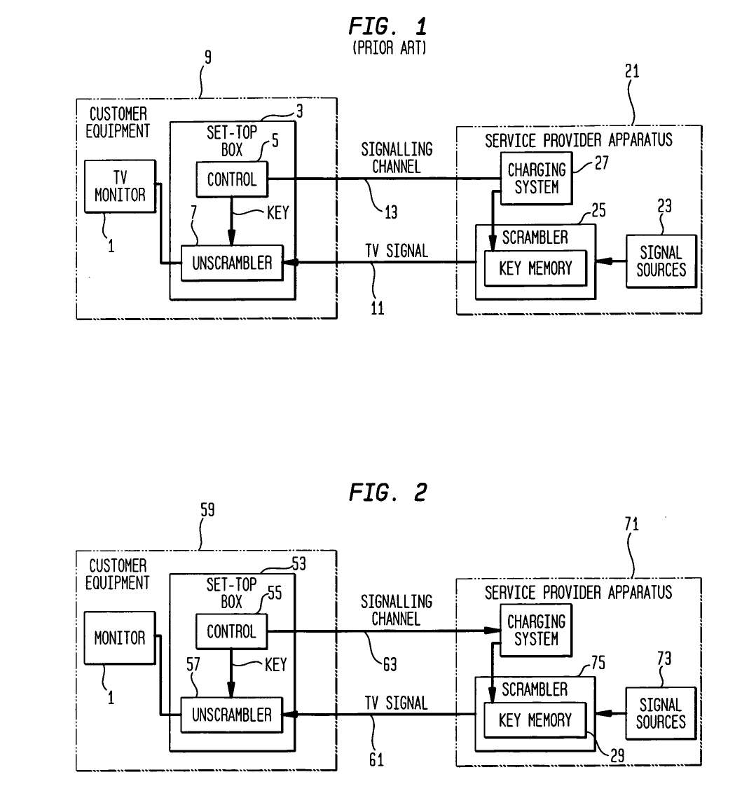

FIG. 1 is a block diagram illustrating the arrangements of a typical arrangement of the prior art. The customer equipment is shown as block 9. A monitor 1 is connected to a set-top box 3. The set-top box includes a control 5 for selecting a channel locally and for signaling over signaling channel 13 a request to the service provider to receive a channel which is not part of the basic group of channels provided to that customer. This request includes an identity of the channel on which the special program is shown, and the duration and time of the program. The TV signal 11 contains the signals of all channels and is scrambled to prevent unauthorized access to the TV signal. The customer's set-top box is initialized with the keys for unscrambling the basic group of channels. In case the customer is requesting a special program, the key for the channel transmitting the special program is transmitted to the set-top box over signaling channel 13. The TV signal received over facility 11 is unscrambled in unscrambler 7 for the channel selected in the control 5 of the set-top box and is then passed to the monitor 1 for viewing.

The service provider equipment 21 contains sources 23 of the TV signals and a scrambler 25 for scrambling the signals of these channels. Scrambler 25 scrambles all the signals received from signal sources 23 and transmits these scrambled signals over facility 11. The additional unscrambling keys for any special programs requested by the customer are sent over the signaling channel 13 from the key memory 29. In addition, charging system 27 receives information from the signaling channel 13 specifying the channel and time of the special program requested by the customer, so that the customer can be charged for access to the special program.

FIG. 2 is a block diagram illustrating the operation of Applicants' invention. The customer equipment is shown as block 59. A monitor, the same monitor 1, is connected to a different set-top box 53. The set-top box 53 is connected to a signaling channel 63 which transmits information concerning any channel to which the customer has set the set-top box for viewing a TV channel. The signaling channel does not receive any unscrambling key information from the service provider. The information from the customer's set-top box is passed to a charging system 77 of the service provider equipment 71; this charging system prepares bills or prepares billing information for use by an off-line billing system (not shown), based on whatever programs the customer has selected and only on those programs. Thus, the customer does not pay for access to programs that the customer is not viewing (i.e., for which the customer's monitor is not receiving a TV signal). The control sends a signal to the unscrambler 57 of the set-top box specifying the channel which is to be presented to monitor 1. The unscrambler 57 then obtains the key for that channel and unscrambles the scrambled TV signal received over facility 61 connecting the customer to the service provider equipment 71.

In the service provider equipment 71, the signal source 73 transmits all channel signals to scrambler 75. Scrambler 75 transmits scrambled versions of all TV channels to the set-top box 53 over TV signal facility 61.

In Applicants' preferred embodiment, when a customer's cable TV set-top box is installed, the scrambling keys of all allowed channels are provided in the set-top box. In the prior art, only the keys to the limited number of channels of the customer's basic service are enabled in the set-top box; a key to a channel for a special program is enabled by a message transmitted over the signaling channel, and is disabled by another message at the end of the program.

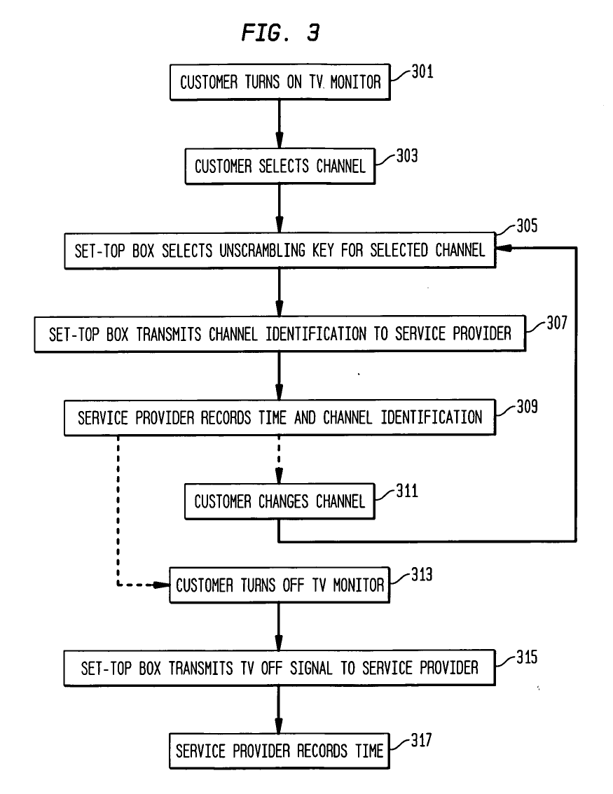

FIG. 3 is a flow diagram illustrating the operation of Applicants' invention. The customer turns on the customer's TV monitor (action block 301). The customer selects the channel to be watched (action block 303) using the set-top box control (or uses a TV channel selection controller (remote) which commands the set-top box for cable channel selection). The set-top box selects the unscrambling key for the selected signal (action block 305); with this selected unscrambling key and the selected channel, and the customer is able to receive the signals from the service provider. The set-top box transmits the channel identification to the service provider (action block 307). The service provider records the time and records the received channel identification (action block 309). The objective is to build up a database of channels and times of TV signals that have been provided to the customer for display on the customer's monitor. Some time later, the customer may take one of two actions. The customer may change channels (action block 311) or may turn off the TV monitor (action block 313). If the customer changes channels, then the actions of action blocks 305-309 are repeated for the new channel. If the customer turns off the TV monitor (action block 313) then the set-top box transmits a TV off signal to the service provider (action block 315) and the service provider records the time at which the monitor was turned off.

The result of executing the steps of FIG. 3 is that the service provider can build up a complete record of the times that each channel was provided to the TV monitor.

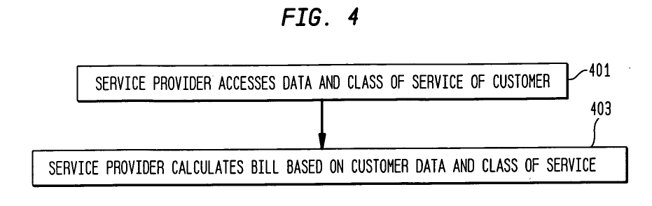

FIG. 4 is a flow diagram illustrating the processing performed by the service provider. The service provider accesses data for the customer and accesses a class of service for that customer (action block 401). The service provider then calculates a customer bill based on the times and channels actually supplied to the customer's monitor and the class of service of the customer (action block 403). The bill calculation can be performed in an off-line processor (not shown).

Many different classes of service may be provided under this arrangement. For example, a customer may be provided with free service (i.e., with service for which no special charge is made) for certain channels and/or for certain channels during certain hours. The charges for certain channels during certain hours may be higher (e.g., for a premium motion picture) or may be lower (for a public service telecast).

The charging algorithms can be completely flexible with this arrangement since the service provider will have a complete record of the times and the channels when the TV monitor is on. Thus, the customer may be charged differently for different channels, for special programs on any channel, for time of day, day of week, day of year, by the number of channels viewed, by time thresholds in total hours for a week or for a month, by thresholds for time watched outside a basic group of channels provided to the customer, or for special one day rentals, for example, to hotel guests. The customer's equipment may be accessed via a radio link, and can be remote from the service provider; in that case, the charges may reflect the geographical location of the customer's equipment at the time a program is being received

The above teachings can also be applied to satellite transmitted TV signals.

The above description is of one preferred embodiment of Applicants' invention. Other embodiments will be apparent to those of ordinary skill in the art The invention is limited only by the attached claims.

We claim:

1. Apparatus for providing a la carte (ALC) charging for viewing cable TV programs comprising:
customer equipment for providing information to a service provider describing a channel and time for any program being displayed on a monitor of said customer equipment; and
apparatus of said service provider for generating billing information based on said information from said customer equipment.

2. The apparatus of claim 1 wherein said customer equipment comprises keys for unscrambling all signals receivable by said customer equipment;
wherein no additional unscrambling information is required from said service provider apparatus for receiving any channel receivable by said customer equipment.

3. The apparatus of claim 1 wherein said customer equipment comprises a set-top box and wherein said set-top box includes unscrambling keys for all channels receivable by said customer equipment;
said set-top box for selecting an unscrambling key corresponding to a channel selected in said customer equipment;
said set-top box for unscrambling signals of the selected channel using an unscrambling key for said selected channel and providing the unscrambled signal to a TV monitor of said customer equipment.

4. The apparatus of claim 3 wherein said set-top box further comprises:
means for sending an identification of a selected channel to said service provider apparatus when said selected channel is turned on.

5. The apparatus of claim 1 wherein said service provider comprises a database for storing information describing times and channels selected in said customer equipment.

6. The apparatus of claim 5 further comprising means for calculating a customer's charges using said information in said database.

7. The apparatus of claim 6 wherein said means for calculating charges comprises means for calculating different charges for different channels.

8. The apparatus of claim 6 wherein said means for calculating charges comprises means for calculating charges based on elapsed time and time for different channels.

9. The apparatus of claim 6 wherein said means for calculating charges comprises means for calculating charges based on time of day and day of week for different channels.

10. The apparatus of claim 1 wherein said customer equipment is connected to said service provider apparatus by a radio link.

11. The apparatus of claim 10 wherein said service provider apparatus generates billing information that is a function of a location of said customer equipment.

12. A method of providing a la carte (ALC) charging for viewing cable TV programs comprising the steps of:
providing information from customer equipment to a service provider apparatus describing a channel and time for any program being displayed on a monitor of said customer equipment; and
apparatus of said service provider for generating billing information based on said information from said customer equipment.

13. The method of claim 12 wherein said customer equipment comprises keys for unscrambling all signals receivable by said customer equipment;
wherein no additional unscrambling information is required from said service provider apparatus for receiving any channel receivable by said customer equipment.

14. The method of claim 12 wherein said customer equipment includes unscrambling keys for all channels receivable by said customer comprising the steps of:
selecting an unscrambling key corresponding to a channel selected in said customer equipment;
using an unscrambling key for said selected channel and providing the unscrambled signal to a TV monitor of said customer equipment.

15. The method of claim 14 further comprising the steps of:
sending an identification of a selected channel to said service provider apparatus when said selected channel is turned on.

16. The method of claim 12 further comprising the step of:
storing information describing times and channels selected in said customer equipment.

17. The method of claim 16 further comprising the step of:
calculating a customer's charges using the stored information.

18. The method of claim 17 wherein the step of calculating charges comprises the step of:
calculating different charges for different channels.

19. The method of claim 17 wherein the step of calculating charges comprises the step of:
calculating charges based on elapsed time and time for different channels.

20. The method of claim 17 wherein the step of calculating charges comprises:
calculating charges based on time of day and day of week for different channels.

21. In a system for providing a la carte (ALC) charging for viewing cable TV programs, a set-top box comprising:
means for deriving information to a service provider indicating a channel and time for any program being displayed on a monitor of customer equipment comprising said set-top box; and
means for transmitting the derived information toward said service provider.

22. The set-top box of claim 21 comprising means for unscrambling any TV signal receivable for said customer equipment.
